(19) United States
(12) Patent Application Publication
(10) Pub. No.: US 2025/0151117 A1
(43) Pub. Date: May 8, 2025

(54) METHOD AND DEVICE FOR RANDOM ACCESS NETWORK

(71) Applicant: BEIJING UNISOC COMMUNICATIONS TECHNOLOGY CO., LTD., Beijing (CN)

(72) Inventor: Huan ZHOU, Shanghai (CN)

(21) Appl. No.: 18/832,628

(22) PCT Filed: Feb. 14, 2022
(86) PCT No.: PCT/CN2022/076146

§ 371 Date: Jul. 24, 2024

(30) Foreign Application Priority Data
Jan. 24, 2022 (WO) PCT/CN2022/073584

(51) Int. Cl. H04W 74/0833; H04W 74/00; H04W 74/08

(52) U.S. Cl. CPC H04W 74/0833; H04W 74/006; H04W 74/0891

(57) ABSTRACT

A communication method is disclosed herein. A base station transmits a message to a user equipment (UE) to trigger a random-access process. The message comprises information for transmitting multiple preambles in one or more physical random-access channels (PRACHs). The base station receives the multiple preambles from the UE and transmits a random-access response to the UE.

### CROSS-REFERENCE TO RELATED APPLICATIONS

This application is the U.S. national phase of International Application No. PCT/CN2022/076146, filed on Feb. 14, 2022, which claims priority to International Application No. PCT/CN2022/073584, filed on Jan. 24, 2022. The disclosures of the aforementioned applications are hereby incorporated by reference in their entireties.

### TECHNICAL FIELD

The present disclosure relates to the field of wireless communication and, more specifically, to random access technologies for a wireless telecommunications network.

### BACKGROUND

The Fifth General (5G) New Radio (NR) technologies provide unprecedented user experience with enormously improved throughput, reduced latency, enhanced coverage and other key performance metrics, comparing to the preceding cellular mobile technologies, such as the Fourth Generation (4G, also known as LTE), the Third Generation (3G, also known as UMTS), and the Second Generation (2G, also known as GSM). 5G NR utilizes a variety of frequency bands, which are divided into Frequency Range 1 (FR1) and Frequency Range 2 (FR2), to accommodate increased usage of mobile communications. At present, FR1 includes frequency bands below 8 gigahertz (GHz), whereas FR2 includes frequency bands in the range of 24-54 GHz. The higher the frequency is, the greater the ability of the frequency band is to support high speeds for data-transfer. However, high frequency bands utilized in 5G NR have reduced travel distances comparing to lower frequency bands, because wireless signals attenuate more quickly with increased carrier frequency. As a result, the coverage of the carrier signals from each base station and terminal device may be limited, thereby causing network connectivity issues that may impact user experience.

In the context of a random-access telecommunications network, such as a 5G NR network, a base station may adjust its transmission power for different terminal devices in different regions of a cell. For example, a base station may increase its transmission power to enhance the downlink coverage. For a terminal device, such as a smartphone, however, it may be difficult to increase the transmission power for the uplink coverage due to power limitations. Consequently, the uplink coverage may be smaller than the downlink coverage in the telecommunications network. Therefore, there is a need for technical solutions to enhance the uplink coverage so as to improve the performance of wireless communication networks and user experience.

### SUMMARY

A communication method, device, and computer readable medium are disclosed to improve RACH processes in 5G NR.

In some embodiments, a method is provided for communication between a base station and a terminal device (e.g., a user equipment (UE)). The method comprises transmitting a message to a UE to trigger a random-access process, receiving multiple preambles from the UE and transmitting a random-access response to the UE. The message comprises information for transmitting multiple preambles in one or more physical random-access channels (PRACHs).

In some embodiments, the information for transmitting multiple preambles indicates the number of preamble indices of the multiple preambles to be transmitted by the UE in the one or more PRACHs.

In some embodiments, the preamble indices of the multiple preambles are the same or different.

In some embodiments, the message includes information indicating a synchronization signal block (SSB) set to be used for transmitting the multiple preambles. The SSB set comprises multiple SSB indices, each SSB index corresponding to an SSB.

In some embodiments, a sequence of the SSBs listed in the SSB set indicates a sequence of SSBs used for transmitting the multiple preambles in time domain.

In some embodiments, the SSB set is indicated by an SSB set index that is included in the message. Correspondences between a plurality of SSB set indices and a plurality of SSB sets are configured through a higher layer signaling.

In some embodiments, the message indicates a set of associations of one or more PRACH occasions to the multiple SSB indices for transmitting the multiple PRACHs.

In some embodiments, the message is transmitted by the base station through a Physical Downlink Control Channel (PDCCH) order.

In some embodiments, a method is provided for communication between a base station and a terminal device (e.g., a UE). The method comprises receiving a message from a base station to trigger a random-access process, transmitting multiple preambles according to the message from the base station, and receiving a random-access response from the base station. The message comprises information for transmitting multiple preambles in one or more physical random-access channels (PRACHs).

In some embodiments, the information for transmitting multiple preambles indicates the number of preamble indices of the multiple preambles to be transmitted by the UE in the one or more PRACHs.

In some embodiments, the preamble indices of the multiple preambles are the same or different.

In some embodiments, the message includes information indicating a synchronization signal block (SSB) set to be used for transmitting the multiple preambles. The SSB set comprises multiple SSB indices, each SSB index corresponding to an SSB.

In some embodiments, a sequence of the SSBs listed in the SSBs set indicates a sequence of SSBs used for transmitting the multiple preambles in time domain.

In some embodiments, the SSB set is indicated by an SSB set index that is included in the message. Correspondences between a plurality of SSB set indices and a plurality of SSB sets are preconfigured through a higher layer signaling.

In some embodiments, the message indicates a set of associations of one or more PRACH occasions to the multiple SSB indices for transmitting the multiple PRACHs.

In some embodiments, the UE receives the message through a Physical Downlink Control Channel (PDCCH) order.

In some embodiments, a device is provided. The device comprises a transceiver configured to transmit a message to a user equipment (UE) to trigger a random-access process, the message comprising information for transmitting multiple preambles in one or more physical random-access channels (PRACHs), receive the multiple preambles from the UE, and transmit a random-access response to the UE.

In some embodiments, a device is provided. The device comprises a transceiver configured to receive a message from a base station to trigger a random-access process, the message comprising information for transmitting multiple preambles in one or more physical random-access channels (PRACHs), transmit the multiple preambles according to the message from the base station, and receive a random-access response from the base station.

In some embodiments, a non-transitory computer-readable medium is provided. The non-transitory computer-readable medium has computer-executable instructions stored thereon. The computer-executable instructions, when executed by one or more processors, cause the one or more processors to facilitate transmitting a message to a user equipment (UE) to trigger a random-access process, the message comprising information for transmitting multiple preambles in one or more physical random-access channels (PRACHs), receiving the multiple preambles from the UE, and transmitting a random-access response to the UE.

In some embodiments, a non-transitory computer-readable medium is provided. The non-transitory computer-readable medium has computer-executable instructions stored thereon. The computer-executable instructions, when executed by one or more processors, cause the one or more processors to facilitate receiving a message from a base station to trigger a random-access process, the message comprising information for transmitting multiple preambles in one or more physical random-access channels (PRACHs), transmitting the multiple preambles according to the message from the base station, and receiving a random-access response from the base station.

### BRIEF DESCRIPTION OF THE DRAWINGS

The subject technology will be described in even greater details below based on the exemplary figures, but is not limited to the examples. All features described and/or illustrated herein can be used alone or in different combinations. The features and advantages of various examples will become apparent by reading the following detailed description with reference to the attached drawings which illustrate the following:

FIG. 1 illustrates an exemplary 5G NR network in accordance with one or more examples.

FIG. 2 illustrates a block diagram of an exemplary base station in accordance with one or more examples.

FIG. 3 illustrates a block diagram of an exemplary user equipment in accordance with one or more examples.

FIG. 4 depicts an exemplary communication process between a base station and a UE in accordance with one or more examples.

FIG. 5 illustrates an exemplary CFRA process in accordance with one or more examples.

FIG. 6 illustrates an exemplary CBRA in accordance with one or more examples.

### DETAILED DESCRIPTION

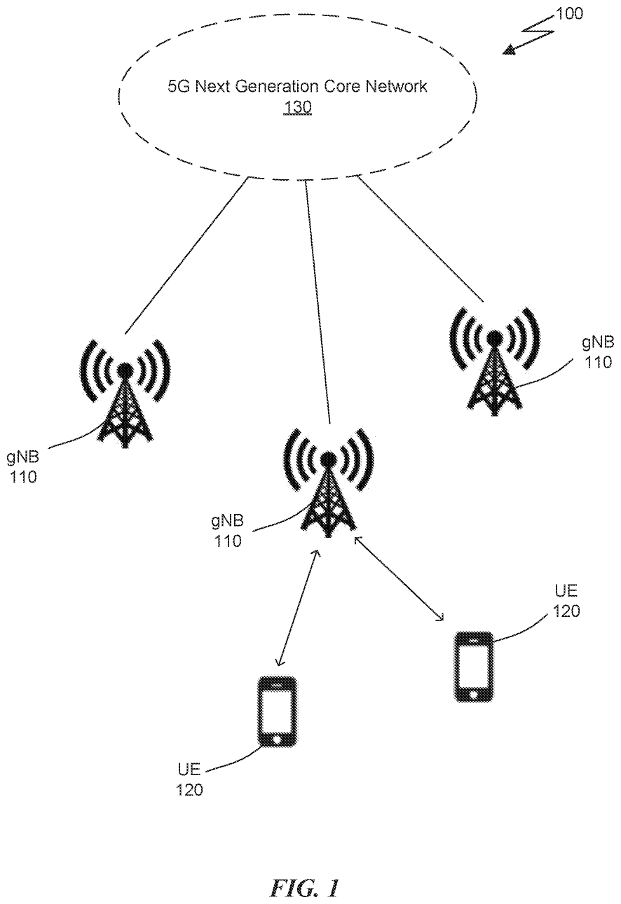

Various examples of the present disclosure provide methods for enabling transmissions of multiple Physical Random-Access Channel (PRACH) preambles in a Random-Access Channel (RACH) process so as to enhance the uplink coverage, thereby improving the success rate of a RACH process in a random-access wireless network, such as a 5G NR network. As depicted in FIG. 1, a random-access wireless network 100 may include elements supporting various telecommunications technologies, such as the 5G NR technologies, according to some embodiments. For example, network 100 may include one or more base stations 110, one or more wireless terminals 120, and a 5G Next Generation (NG) core network (CN) 130. In some embodiments, wireless terminal 120 may be called user equipment (UE), and base station 110 may be called a Next Generation NodeB (gNB). gNB 110 may provide 5G NR user plane and control plane transmissions towards terminals 120, so as to allow terminals 120 to connect to core network 130 using a 5G NR air interface.

According to some embodiments, before terminal 120 is connected to network 100, terminal 120 may need to synchronize with one of gNBs 110 in downlink and/or in uplink. In a 5G NR network, a downlink is a channel that carries data from gNB 110 to terminal 120, while an uplink is a channel that carries data from terminal 120 to gNB 110. In order to perform processes such as an uplink synchronization, terminal 120 may perform an initial access comprising a sequence of process between terminal 120 and gNB 110, which is defined as a RACH process.

The RACH is a shared channel used by wireless terminals 120 to access network 100. The RACH is a transport-layer channel, and the corresponding physical-layer channel is called Physical RACH (PRACH). According to the 5G standards, terminal 120 may perform a RACH process to re-establish the uplink synchronization and/or the RRC connection with gNB 110. According to some embodiments, there may be two types of RACH processes, a Contention-Based Random-Access (CBRA) and a Contention-Free Random-Access (CFRA).

The RACH process may be triggered by various events, such as initial access, beam failure recovery, synchronization, and other events. According to an embodiment, when terminal 120 initiates a RACH process with gNB 110, terminal 120 and gNB 110 may exchange random-access messages (e.g., a random-access preamble or a random-access response) to perform uplink synchronization. Specifically, unlike the terminals in existing telecommunications networks, where the terminals transmits only a single random-access preamble (i.e., a PRACH preamble) to the base stations for initiating a random access, terminal 120 may transmit a plurality of random-access preambles (i.e., PRACH preambles) to gNB 110 for the RACH process. In response, gNB 110 may transmit a random-access response in response to the received PRACH preamble. The transmissions of multiple PRACH preambles may ensure that at least one of the PRACH preambles from terminal 120 arrives at gNB 110, thus improving the success rate of the uplink synchronization.

According to a further embodiment, in network 100, the RACH process may be initiated by gNB 110 sending a message, such as a Physical Downlink Control Channel (PDCCH) order, to terminal 120. The PDCCH order may be configured to include information indicating transmissions of the multiple PRACH preambles. Once terminal 120 receives the PDCCH order, terminal 120 may determine multiple instances or repetitions of the PRACH preambles to be transmitted based on the information included in the PDCCH order. In some examples, the multiple PRACH preambles transmitted by terminal 120 may be the instances of the same PRACH preamble or different preambles.

In some embodiments, the information of the PDCCH order from gNB 110 may include the number of transmissions of the multiple PRACH preambles. When terminal 120 obtains the information from the PDCCH order, terminal 120 determines the number of PRACH preambles to be transmitted based on the information, which is indicated in the PDCCH order. In some variations, the information may include additional information indicating associations of the PRACH preambles to one or more Synchronization Signal Blocks (SSBs). The SSBs are related to time-frequency resources used for the transmissions of the multiple PRACH preambles.

According to an embodiment, the information of the PDCCH order may identify a number of SSBs that are used to transmit the multiple PRACH preambles. The number of SSBs specified in the PDCCH order may be the same as the number of the transmissions of the multiple PRACH preambles. The plurality of SSBs identified in the PDCCH order may include identical SSBs or different SSBs, which may be related to identical or different beamforming for the transmissions of the PRACH preambles. In some examples, the plurality of SSBs are indicated as a set of SSB indices in the PDCCH order. The set of SSB indices indicates not only the number of PRACH preambles to be transmitted by including multiple SSBs corresponding to the transmissions of the multiple PRACH preambles, but also the sequence for the transmissions of the multiple PRACH preambles according to the sequence of the SSBs listed in the set of SSB indices. When terminal 120 obtains the set of SSB indices from the PDCCH order, terminal 120 determines SSBs corresponding to the SSB indices based on correspondences configured through a higher layer signaling (e.g., a RRC signaling). In some instances, terminal 120 may obtain the configured correspondences from gNB 110 through a high layer signaling, and store the correspondences locally, so as to determine the corresponding SSBs based on the configured correspondences.

Terminal 120 performs transmissions of the multiple PRACH preambles based on the information indicated in the received PDCCH order from gNB 110. After gNB 110 receives one or more PRACH preambles from terminal 120 in a set time period, gNB 110 may transmit a random-access response to terminal 120. By enabling transmissions of the multiple PRACH preambles from terminal 120 to gNB 110 during the RACH process, the uplink coverage from terminal 120 in network 100 may be greatly enhanced. As a result, the success rate of a RACH process and the user experience may be improved.

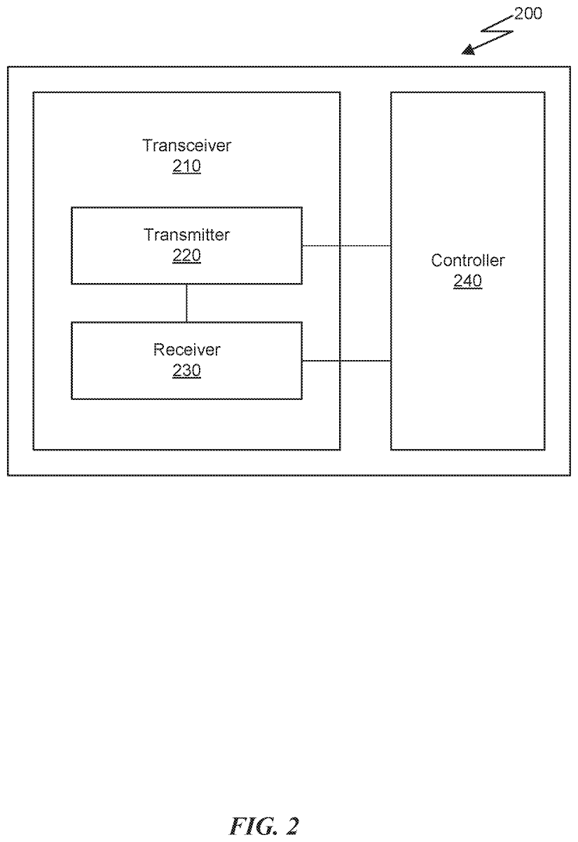

FIG. 2 illustrates a block diagram of an exemplary base station 200 that may be used to implement gNB 110 of network 100 in accordance with one or more examples. Base station 200 may include, among other components, a transceiver 210 and a controller 240. Transceiver 210 includes a transmitter 220 and a receiver 230. Receiver 230 includes radio frequency (RF) circuitry (e.g., front-end filters, low noise amplifiers, switches), one or more antenna, and other components, which are configured to receive data and/or control signals. Transmitter 220 may also include RF circuitry (e.g., for power amplifiers), one or more antenna and other components, which are configured to transmit data and/or control signals. Controller 240 may be configured to perform processes, such as encoding/decoding to the data/control signals. Controller 240 may further include one or more processors and a memory that stores computer-readable instructions. The computer-readable instructions, when executed by the one or more processors, can cause the one or more processors to perform various processes disclosed in the present disclosure. The memory may be any non-transitory type of storage, such as volatile or non-volatile, magnetic, semiconductor-based, tape-based, optical, removable, non-removable, or other type of storage device or tangible computer-readable medium including, but not limited to, a read-only memory (ROM), a flash memory, a dynamic random-access memory (RAM), and/or a static RAM.

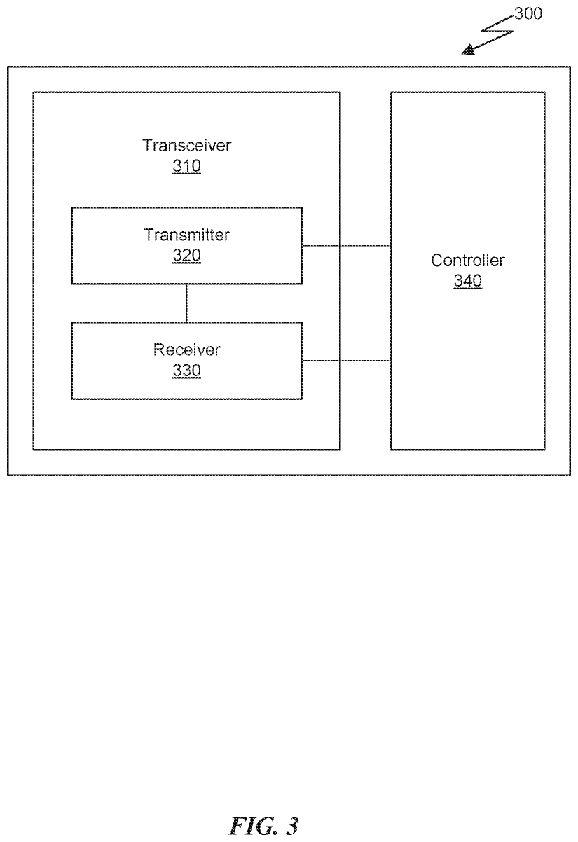

FIG. 3 illustrates a block diagram of an exemplary terminal 300 that may be used to implement terminal 120 of network 100 in accordance with one or more examples. In a 5G NR network, a terminal is also called UE that may be a subscriber's mobile device, such as a cell phone, tablet, modem, automobile, or other types of devices that support wireless telecommunication. Terminal 300 may include, among other components, a transceiver 310 and a controller 340. Transceiver 310 may include a transmitter 320 and a receiver 330. Receiver 330 may include RF circuitry (e.g., front-end filters, low noise amplifiers, switches), one or more antenna, and other components, which are configured to receive data and/or control signals. Transmitter 320 may also include RF circuitry (e.g., power amplifiers), one or more antenna, and other components, which are configured to transmit data and/or control signals. Controller 340 may be configured to perform processes, such as encoding/decoding, on the data/control signals. Controller 240 may further include one or more processors and a memory that stores computer-readable instructions. The computer-readable instructions, when executed by the one or more processors, may cause the one or more processors to perform various processes disclosed in the present disclosure. The memory may be any non-transitory type of storage, such as volatile or non-volatile, magnetic, semiconductor-based, tape-based, optical, removable, non-removable, or other type of storage device or tangible computer-readable medium including, but not limited to, a read-only memory (ROM), a flash memory, a dynamic random-access memory (RAM), and/or a static RAM.

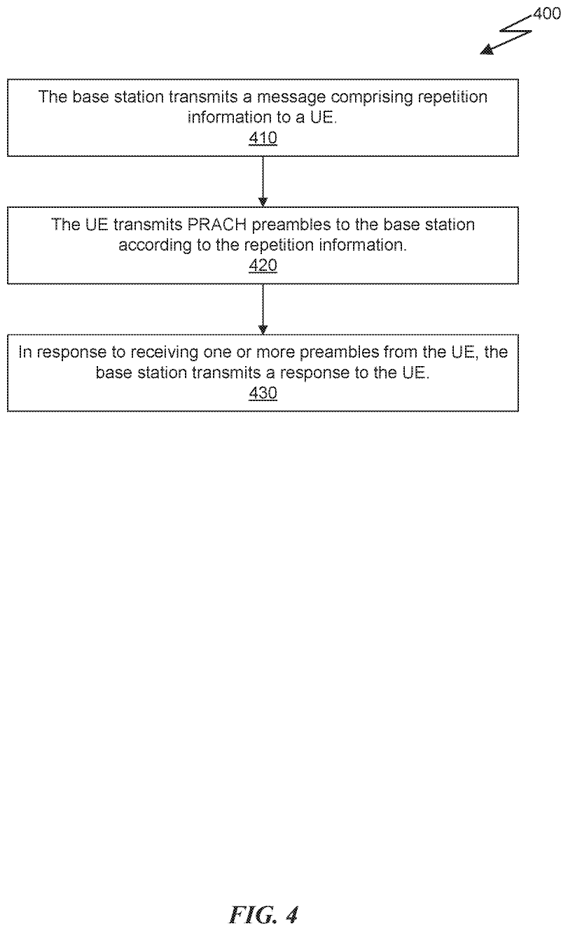

FIG. 4 depicts an exemplary communication process 400 for communication between a base station (such as gNB 110 or base station 200) and a UE (such as terminal 120 or 300) in accordance with one or more examples. Process 400 comprises steps that may be executed during a RACH process performed between the base station (e.g., gNB 110 as shown in FIG. 1) and the UE (e.g., terminal 120 as shown in FIG. 1). For example, the RACH process may be triggered by the base station through a PDCCH order in order to perform uplink synchronization with the UE. In a 5G NR network, two types of RACH process, which are CBRA and CFRA processes, may be triggered by a number of events, including initial access, RRC connection re-establishment procedure, beam failure recovery and other events. In the CBRA, the UE may randomly select a random-access preamble from a pool of preambles shared with other UEs in a cell. In CFRA, the UE may use a dedicated preamble provided by the network (e.g., gNB 110) to this UE via RRC signaling or a PDCCH order. The type of the RACH process to be triggered may be indicated by the PDCCH order. For instance, a PDCCH order may include a field indicating a random-access preamble index, which may be set to all zeros to indicate the CBRA, or other values to indicate the CFRA. The PDCCH order is a special form of downlink control information (DCI). The DCI may have different formats associated with different events. For instance, DCI format 1_0 with cyclic redundancy check (CRC) scrambled by the cell radio network temporary identifier (C-RNTI) may be utilized for the PDCCH order, when the field of Identifier for DCI formats is set to 1 and the field of Frequency domain resource assignment is set to all ones. Table 1 shows an exemplary PDCCH order comprising multiple fields.

TABLE 1
An exemplary DCI format 1_0 with
CRC scrambled by C-CNTI for PDCCH Order.

| DCI Field | Size (bits) | Description |
|---|---|---|
| Identifier for DCI formats | 1 | Set to 1 for DL |
| Frequency domain resource | Variable | Set to all ones. |
| assignment | | |
| Random-Access Preamble index | 6 | Set to all zeros for |
| | | CBRA, or other values |
| | | for CFRA. |
| Uplink (UL)/Supplementary UL | 1 | Depending on CBRA or |
| (SUL) indicator | | CFRA. |
| Synchronization Signals (SS)/ | 6 | Depending on CBRA or |
| Physical Broadcast Channel | | CFRA. |
| (PBCH) index | | |
| PRACH Mask index | 4 | Depending on CBRA or |
| | | CFRA. |
| Reserved | 12 or 10 | Reserved bits. |

According to a further embodiment, when a CBRA process is triggered according to the PDCCH order, the field of Random-Access Preamble index is set to all zeros, and the bits in the UL/SUL indicator, SS/PBCH (referred as SSB) index, and PRACH mask index are defined as reserved bits without providing information as originally defined. When a CFRA process is triggered according to the PDCCH order, the Random-Access Preamble index may indicate an index corresponding to a preset preamble that is configured through a higher layer signaling (e.g., a RRC signaling) or the PDCCH order. The UL/SUL indicator indicates which UL carrier (e.g., the SSB) in a cell is used for transmitting the PRACH preamble, when a SUL is configured. When a SUL is not configured, the bit in the field of UL/SUL indicator is reserved. The SS/PBCH indicator indicates an SS/PBCH that shall be used to determine a PRACH occasion (referred as a RO) for the PRACH transmission. The PRACH Mask index indicates which PRACH resource that the UE is allowed to use for transmitting a PRACH preamble. The PRACH resource is defined as a PRACH occasion in a PRACH slot/frame. The PRACH Mask index indicates a RO associated with the SS/PBCH indicated by the SS/PBCH index for the PRACH transmission. Table 2 shows an exemplary configuration of RO associations.

TABLE 2
An exemplary configuration of PRACH Mask index
corresponding to PRACH occasion(s) of SSB.

| PRACH Mask index | Allowed PRACH occasion(s) of SSB |
|---|---|
| 0 | All |
| 1 | PRACH occasion index 1 |
| 2 | PRACH occasion index 2 |
| 3 | PRACH occasion index 3 |
| 4 | PRACH occasion index 4 |
| 5 | PRACH occasion index 5 |
| 6 | PRACH occasion index 6 |
| 7 | PRACH occasion index 7 |
| 8 | PRACH occasion index 8 |
| 9 | Every even PRACH occasion |
| 10 | Every odd PRACH occasion |
| 11 | Reserved |
| 12 | Reserved |
| 13 | Reserved |
| 14 | Reserved |
| 15 | Reserved |

At step 410 according to some embodiments, the base station transmits a message to the UE, and the message comprises information for transmissions of multiple PRACH preambles from the UE to the base station. In some examples, the message may be a PDCCH order that triggers a RACH process between the UE and the base station. The PDCCH order is a special form of DCI. In some instances, a DCI format 1_0 with CRC scrambled by C-CNTI as shown in Table 1 may be utilized as a PDCCH order. The field of Identifier for DCI formats is set to 1 to indicate a downlink (DL) transmission of the PDCCH order, and the field of Frequency domain resource assignment is set to all ones, such that the DCI is set to be a PDCCH order.

When the PDCCH order triggers a CBRA, according to an embodiment, the Random-Access Preamble index is set to all zeros, and the following bits are set to be reserved bits. In some instances, some of the reserved bits in the PDCCH order may be set to include information indicating transmissions of multiple PRACH preambles. For instance, one or more bits in the PDCCH order may indicate the number of PRACH preambles to be transmitted. Additionally, and/or alternatively, one or more bits in the PDCCH order may indicate associations of multiple SSBs to the ROs. The SSBs identified in the PDCCH order may be the same or different SSBs.

When the PDCCH order triggers a CFRA, according to an embodiment, the Random-Access Preamble index may be set to a value that indicates that a PRACH preamble is to be transmitted for multiple times. In some variations, the Random-Access Preamble index may be set to indicate a set of preambles to be transmitted. The set of preambles may include instances of the same or different preambles.

According to a further embodiment, the field of SS/PBCH may indicate a set of SSB indices. The set of SSB indices may include multiple SSB indices that are identical or different. Each SSB index is associated with an SSB. The associations of the SSB indices with the SSBs may be configured through a higher layer signaling (e.g., a RRC signaling). The number of the SSB indices may be the same as the number of multiple PRACH preambles to be transmitted from the UE to the base station. The sequence of the SSBs in the set indicates a time-domain allocation of the SSBs to transmit multiple instances PRACH preamble. When the Random-Access Preamble index indicates a single preamble, the UE transmits the preamble for multiple times using the SSBs indicated in the set of SSBs according to the sequence of the SSB indices indicated in the set of SSBs. When the Random-Access Preamble index indicates a set of preambles, each preamble in the set may be associated with an SSB index in the set of SSBs according to a one-to-one correspondence. In some examples, the PDCCH order may further include a field (e.g., comprising 1 bit) to indicate an on/off status of the transmissions of multiple PRACH preambles. In some instances, the PRACH Mask index may be an index for an allowed RO to transmit the multiple instances of the PRACH preamble as shown in Table 2. To this end, all the SSBs identified in the set are linked to the RO based on the correspondence indicated by the PRACH Mask index. Additionally and/or alternatively, the PRACH Mask index may indicate a set of allowed ROs, where each allowed RO may be linked to an SSB index in the set of SSBs. In other words, the multiple PRACH preambles may be transmitted using multiple SSBs on different ROs.

After the base station transmits the message (e.g., the PDCCH order) to the UE, the base station may monitor the uplink channel to detect whether one or more PRACH preambles from the UE are received in a set time period. Specifically, according to some embodiments, at step 420, after receiving the message (e.g., the PDCCH order) from the base station, the UE transmits multiple instances of the PRACH preamble to the base station according to the information specified in the message from the base station. The UE may first determine the type of RACH process triggered by the PDCCH order.

When a CFRA process is triggered according to the PDCCH order, the UE may determine one or more PRACH preambles based on the information provided in the PDCCH order. The UE may further determine resources (e.g., SSBs, ROs) for transmitting the multiple instances of the PRACH preamble.

When a CBRA process is triggered, the UE may select one or more preambles from a pool of preambles available to the UE. The UE further determines resources (e.g., SSBs, ROs) for transmitting the multiple instances of the PRACH preamble.

After the UE transmits multiple instances of the PRACH preamble to the base station, the UE may wait for an acknowledgement from the base station in the form of a random-access response.

At step 430, in response to reception of one or more PRACH preambles from the UE, the base station may transmit a random-access response to the UE. After transmitting the PDCCH order to the UE, the base station waits to receive one or more preambles from the UE in a set time period. In the time period, the base station may receive one or more PRACH preambles from the UE. In response to reception of the one or more PRACH preambles from the UE, the base station may determine a random-access response to be transmitted to the UE to complete the RACH process. Further, if the base station receives multiple instances of the PRACH preambles in the time period, the base station may determine a random-access response based on a PRACH preamble with the strongest signal. In some instances, the base station may not receive any of the PRACH preambles transmitted by the UE. To this end, the base station may determine to send another message (e.g., a PDCCH order) to the UE to retry the RACH process. Alternatively, the UE may determine to retry the RACH process on its own if no random-access response from the base station is received within a time period.

Although the process 400 describes a PDCCH order being utilized to trigger transmissions of multiple PRACH preambles, it will be appreciated that the transmissions of multiple PRACH preambles may be triggered by other types of messages, such as the short physical uplink control channel (PUCCH) formats, by applying the techniques disclosed in the present disclosure.

The following examples describes various embodiments for transmissions of multiple PRACH preambles in a 5G NR network, such as network 100 of FIG. 1. The techniques disclosed herein may be applied to a network including a plurality of terminals (i.e., UE) and base stations (i.e., gNB), which support 5G NR technologies.

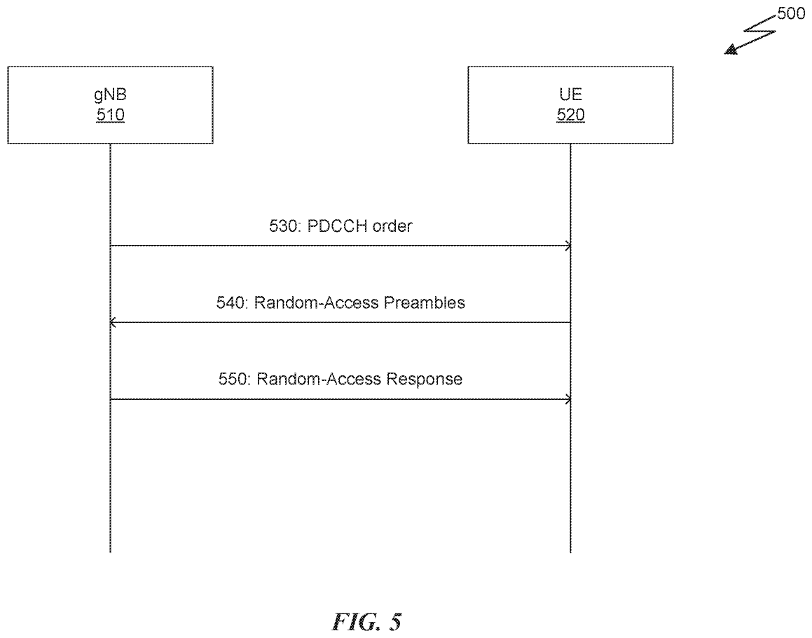

FIG. 5 illustrates an exemplary CFRA process 500 according to some embodiments. Referring to FIG. 5, the CFRA process 500 includes steps that may be performed by a UE 520 and/or a gNB 510, which both support the 5G NR technologies.

At step 530, gNB 510 transmits a PDCCH order to UE 520. The PDCCH order may be a DCI format 1_0 with CRC scrambled by C-CNTI. In the PDCCH order, the field of Identifier for DCI formats is set to 1 and the field of Frequency domain resource assignment is set to all ones. The field of Random-Access Preamble index is set to be a non-zero value, such that a CFRA process is to be triggered by the PDCCH order. The PDCCH order includes an SS/PBCH index field comprising 6 bits. The SS/PBCH index field may indicate an index (referred to as an SSB set index) for a set of SSB indices, where the set of SSB indices is referred to as an SSB set. The SSB set index indicated in the SS/PBCH index field may be integers, such as 0, 1, 2, and so on. When the SS/PBCH includes 6 bits, the maximum number of SSB set indices may be 26. Each index is associated with a preconfigured SSB set. Each SSB set may include multiple SSB indices. According to an embodiment, an SSB set may include a single SSB, which indicates an off status for the transmissions of multiple PRACH preambles. In other words, an SSB set including a single SSB may indicate that the PRACH preamble is to be transmitted once. According to a further embodiment, for example, an SSB set comprising multiple SSB indices may be {0, 0, 0, 0}, {0, 1, 0, 1}, {3, 2, 1, 0}, {0, 0}. The correspondences between the SSB set indices and the SSB sets may be configured through a high layer signaling (e.g., a RRC signaling). Table 3 illustrates exemplary correspondences between SSB set indices and SSB sets.

TABLE 3
Correspondences between the SSB set indices and the SSB sets.

| SSB set index | SSB indices in one SSB set |
|---|---|
| 0 | {0, 0, 0, 0} |
| 1 | {0, 1, 0, 1} |
| 2 | {3, 2, 1, 0} |
| 3 | {0, 0} |

As shown in Table 3, different numbers of SSB indices may be included in the SSB sets. The number of SSB indices included in an SSB set may correspond to the number of PRACH preambles to be transmitted. In some variations, the PDCCH order may indicate a number of PRACH preambles to be transmitted that is different from the number of SSB indices included in the SSB set as indicated by the SSB set index. The UE may determine the SSBs to be utilized for transmitting the PRACH preamble(s) based on the number of transmissions indicated by the PDCCH order. Each SSB index in an SSB set corresponds to an SSB for transmitting the PRACH preamble. Different SSB indices may correspond to different SSBs. The sequence of the SSB indices in the SSB set indicates a sequence for transmitting the PRACH preamble(s) in the time domain. The following examples describes the transmissions of multiple PRACH preambles according to the SSB set indices as shown in Table 3.

According to an embodiment as shown in Table 3, SSB set index 0 may correspond to SSB set {0, 0, 0, 0}, which specifies four SSB indices that are all 0. Thus, when the SSB set index is set to 0 in the PDCCH order from gNB 510, four PRACH preambles are to be transmitted sequentially by UE 520 on SSB 0. The four PRACH preambles transmitted on SSB 0 may be four instances of the same PRACH preamble. In other words, the transmission of the same PRACH preamble may be repeated four times on SSB 0. Alternatively, the four PRACH preambles may be instances of different PRACH preambles.

According to an embodiment as shown in Table 3, SSB set index 1 may correspond to SSB set {0, 1, 0, 1}, which specifies four SSB indices that are either 0 or 1. Thus, when the SSB index is set to 1 in the PDCCH order from gNB 510, four PRACH preambles are to be transmitted sequentially by UE 520 according to the order of the SSB numbers in the SSB set. Specifically, the first PRACH preamble may be transmitted on SSB 0, the second PRACH preamble may be transmitted on SSB 1, the third PRACH preamble may be transmitted on SSB 0, and the fourth PRACH preamble may be transmitted by SSB 1. According to a further embodiment, the four PRACH preambles transmitted on SSBs 0 and 1 may be instances of the same PRACH preamble or different PRACH preambles. For example, the PRACH preambles transmitted on SSB 0 may be instances of a first PRACH preamble, while the PRACH preambles transmitted on SSB 1 may be instances of a second PRACH preamble. Accordingly, the transmission of the first PRACH preamble may be repeated twice on SSB 0, while the transmission of the second PRACH preamble may be repeated twice on SSB 1.

According to an embodiment as shown in Table 3, SSB set index 2 may correspond to SSB set {3, 2, 1, 0}, which specifies four SSB indices that are 3, 2, 1, and 0. Thus, when the SSB index is set to 2 in the PDCCH order from gNB 510, four PRACH preambles are to be transmitted sequentially by UE 520 according to the order of the SSB numbers in the SSB set. Specifically, the first PRACH preamble may be transmitted on SSB_3, the second PRACH preamble may be transmitted on SSB_2, the third PRACH preamble may be transmitted on SSB_1, and the fourth PRACH preamble may be transmitted on SSB0. According to a further embodiment, the four PRACH preambles transmitted on SSBs 3, 2, 1 and 0 may be instances of the same PRACH preamble or different PRACH preambles. For example, the PRACH preamble transmitted on SSB 0 may be an instance of a first PRACH preamble, the PRACH preamble transmitted on SSB 1 may be an instance of a second PRACH preamble, the PRACH preamble transmitted on SSB_2 may be an instance of a third PRACH preamble, and the PRACH preamble transmitted on SSB_3 may be an instance of a fourth PRACH preamble. Accordingly, four different PRACH preambles may be transmitted on the SSBs.

According to an embodiment as shown in Table 3, SSB set index 3 may correspond to SSB set {0, 0}, which specifies two SSB indices that are all 0. Thus, when the SSB index is set to 3 in the PDCCH order from gNB 510, two PRACH preambles are to be transmitted sequentially by the UE 520 on SSB_0. The two PRACH preambles transmitted on SSB_0 may be two instances of the same PRACH preamble. In other words, the transmission of the same PRACH preamble may be repeated twice on SSB_0. Alternatively, the two PRACH preambles may be instances of different PRACH preambles.

The SSB set indices and the SSB sets described above are merely exemplary embodiments. Other variations of the SSB set indices and SSB sets may be readily appreciated by one of ordinary skill in the art and within the scope of this disclosure.

The RO(s) corresponding to the SSB is indicated by the field of PRACH Mask index in the PDCCH order. As mentioned-above, the PRACH Mask index may indicate one or more ROs that are associated with the SSBs included in the SSB set.

In some variations, different SSB sets may be configured for different SSB set indices. Part or all of the available SSB indices may be configured for the SSB sets. For example, when the SSB set index is represented by 6 bits, the maximum number of SSB sets may be 64. When part of the available SSB indices are configured for the SSB sets, the SSB indices that are not utilized may be set to a reserved status, which may be utilized for the same or other purposes later. The configurations of the SSB sets corresponding to the SSB set indices may be dynamically updated. In some examples, some or all of the correspondences between the SSB sets and the SSB set indices may be configured by gNB 510 and/or UE 510. gNB 510 and UE 520 may synchronize configuration of the correspondences between the SSB sets and the SSB set indices through a higher layer signaling (e.g., a RRC signaling). The synchronization may include the entire list of the SSB indices, or a part of the list of the SSB indices.

After gNB 510 transmits the PDCCH order to UE 520, gNB 510 may monitor the uplink channel for reception of one or more PRACH preambles from UE 520 in a set time period.

At step 540, UE 520 may transmits multiple random-access preambles (e.g., the PRACH preambles) to gNB 510. UE 520 may determine whether to transmit different PRACH preambles or a single PRACH preamble by multiple times based on the information indicated in the PDCCH order from gNB 510. The field of Random-Access Preamble index may indicate a single preamble for UE 520 to transmit for multiple times. Alternatively, the field of Random-Access Preamble index may indicate a set of preambles for UE 520 to transmit during the transmissions of the multiple PRACH preambles. The UE 520 determines multiple SSBs for transmitting the multiple PRACH preambles based on the information indicated in the field of SS/PBCH index in the PDCCH order. The SS/PBCH index field may indicate an SSB set index. The UE may determine an SSB set corresponding to the SSB set index based on a list of correspondences such as Table 3 above that may be stored in UE 520. The SSB set may include one or more SSB indices that are listed in a sequence, such as those shown in Table 3 above. In some instances, UE 520 may determine the number of transmissions of the multiple PRACH preambles based on the number of SSB indices included in the SSB set. Additionally and/or alternatively, UE 520 may determine the sequence of the SSBs to be used for transmitting the PRACHs based on the sequence of the SSBs listed in the SSB set. UE 520 may further determine one or more ROs that are associated with the SSBs indicated by the SSB set index in the PDCCH order. Then, UE 520 may transmit the PRACH preambles sequentially by using the SSBs with the associated the RO(s).

gNB 510 may receive one or more PRACH preambles from UE 520 in the set time period following the transmission of the PDCCH order to UE 520. Since UE 520 is enabled to transmit multiple PRACH preambles, the probability of receiving at least one PRACH preamble by gNB 510 is significantly increased in comparison with existing telecommunications networks. As such, the success rate of a RACH process between gNB 510 and UE 520 is greatly improved. User experience is thus enhanced.

Upon transmitting the PRACH preamble(s) at step 540, UE 520 may wait for an acknowledgement from gNB 510 in the form of a random-access response. In some variations, UE 520 may monitor the downlink channel for a random-access response by attempting to detect a DCI format 1_0 with CRC scrambled by Random-Access RNTI (RA-RNTI)/C-RNTI within a set time period.

At step 550, gNB 510 may transmit a random-access response to UE 520 in response to the reception of one or more PRACH preambles from UE 520. When gNB 510 receives one or more instances of the PRACH preambles from UE 520, the gNB 510 may determine a PRACH preamble with the strongest signal and transmit a random-access response in response to the PRACH preamble with the strongest signal.

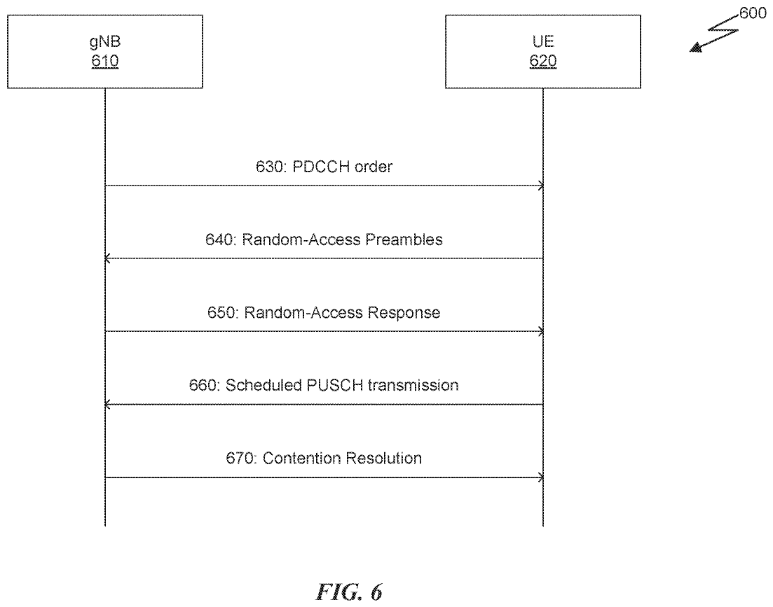

FIG. 6 illustrates an exemplary CBRA process 600 according to some embodiments. Referring to FIG. 6, CBRA process 600 may include steps 630-670 that are performed by a terminal (e.g., UE 620) and/or a base station (e.g., gNB 610), which both support the 5G NR technologies.

According to CBRA process 600, at step 630, gNB 610 transmits a PDCCH order to UE 620. The PDCCH order may be a DCI format 1_0 with CRC scrambled by C-CNTI. In the PDCCH order, the field of Identifier for DCI formats is set to 1 and the field of Frequency domain resource assignment is set to all ones. The field of Random-Access Preamble index is set to all zeros, such that a CBRA process is triggered according to the PDCCH order. The reserved bits in the PDCCH order may include information indicative of the number of PRACH preambles transmitted.

In some embodiments, the PDCCH order may include a field comprising 2 bits to indicate the number of PRACH preambles to be transmitted by UE 620. The 2-bit field may indicate up to 4 different numbers of transmissions, for example, 0 for a single PRACH preamble, 1 for two PRACH preambles, 2 for three PRACH preambles, and 3 for four PRACH preambles.

In some embodiments, the PDCCH order may include a field comprising 1 bit to indicate whether to associate a RO for transmitting the PRACH preambles on the same or different SSBs.

In some embodiments, the PDCCH order may include the aforementioned fields to indicate both a number of PRACH preambles and whether to associate a RO to the same or different SSBs.

After gNB 610 transmits the PDCCH order to UE 620, gNB 610 may monitor the uplink channel for the reception of one or more PRACH preambles from UE 620 in a set time period.

At step 640, UE 620 may transmit multiple random-access preambles (e.g., the PRACH preambles) to gNB 610. UE 620 may determine the SSBs and the associated ROs for transmitting the PRACH preambles. UE 620 may determine the number of SSBs based on the number of PRACH preambles that is indicated in the PDCCH order. UE 620 may determine whether to transmit instances of different PRACH preambles or instances of the same PRACH by multiple times. In some embodiments, UE 620 may determine whether to select multiple PRACH preambles based on a field included in the PDCCH order. UE 620 may select one or more PRACH preambles randomly from a pool of preambles that are shared with other UE(s).

Once a PRACH preamble is transmitted, UE 620 may wait for an acknowledgement from gNB 610 in the form of a random-access response. In some embodiments, UE 620 may monitor the downlink channel for a random-access response from the gNB by attempting to detect a DCI format 1_0 with CRC scrambled by RA-RNTI/C-RNTI within a set time period.

At step 650, gNB 610 transmits a random-access response to UE 620 in response to the reception of one or more instances of the PRACH preamble. When gNB 610 receives different instances of the PRACH preambles from UE 620, gNB 610 may determine a PRACH preamble with the strongest signal and transmit a random-access response in response to the PRACH preamble with the strongest signal.

At step 660, UE 620 may transmit a scheduled physical uplink shared channel (PUSCH) transmission to gNB 610. In a CBRA process, other UEs may transmit the same PRACH(s) to gNB 610. All the UEs transmitting the same PRACH preambles may receive and decode the same random-access response from gNB 610. As a result, those UEs decoding the same random-access response transmit the PUSCH transmissions on the same UL time/frequency resources, such as the same SSBs.

At step 670, gNB 610 transmits a contention resolution to UE 620. The contention may be resolved by the network (e.g., gNB 610). If UE 620 determines the contention is successful based on the contention resolution, CBRA process 600 is completed. If UE 620 determines that the contention resolution is not successful, UE 620 may return to the process of selecting a PRACH preamble and retry the RACH process.

According to an embodiment, CFRA process 500 and CBRA process 600 may be selected by the UE and/or the gNB for random-access process between the gNB and the UE. According to another embodiment, CBRA process 600 as shown in FIG. 6 may be set as a fallback process. When CFRA process 500 fails (e.g., if the gNB fails to receive any PRACH preambles from the UE within a set time period), the UE may switch to CBRA 600 in an attempt to communicate with the gNB.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

It should be understood that the arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. It will be recognized by those skilled in the art that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

1. A communication method, comprising:
transmitting, by a base station, a message to a user equipment (UE) to trigger a random-access process, the message comprising information for transmitting multiple preambles in one or more physical random-access channels (PRACHs);
receiving, by the base station, the multiple preambles from the UE; and
transmitting, by the base station, a random-access response to the UE.

2. The method according to claim 1, wherein:
the information for transmitting multiple preambles indicates the number of preamble indices of the multiple preambles to be transmitted by the UE in the one or more PRACHs.

3. The method according to claim 2, wherein the preamble indices of the multiple preambles are the same.

4. The method according to claim 2, wherein the preamble indices of the multiple preambles are different.

5. The method according to claim 1, wherein:
the message includes information indicating a synchronization signal block (SSB) set to be used for transmitting the multiple preambles, and
the SSB set comprises multiple SSB indices, each SSB index corresponding to an SSB.

6. The method according to claim 5, wherein a sequence of the SSBs listed in the SSB set indicates a sequence of SSBs used for transmitting the multiple preambles in time domain.

7. The method according to claim 5, wherein the SSB set is indicated by an SSB set index that is included in the message, and wherein correspondences between a plurality of SSB set indices and a plurality of SSB sets are configured through a higher layer signaling.

8. The method according to claim 5, wherein the message indicates a set of associations of one or more PRACH occasions to the multiple SSB indices for transmitting the multiple PRACHs.

9. The method according to claim 1, wherein the message is transmitted by the base station through a Physical Downlink Control Channel (PDCCH) order.

10. A communication method, comprising:
receiving, by a UE, a message from a base station to trigger a random-access process, the message comprising information for transmitting multiple preambles in one or more physical random-access channels (PRACHs);
transmitting, by the UE, the multiple preambles according to the message from the base station; and
receiving, by the UE, a random-access response from the base station.

11. The method according to claim 10, wherein:
the information for transmitting multiple preambles indicates the number of preamble indices of the multiple preambles to be transmitted by the UE in the one or more PRACHs.

12. The method according to claim 11, wherein the preamble indices of the multiple preambles are the same.

13. The method according to claim 11, wherein the preamble indices of the multiple preambles are different.

14. The method according to claim 10, wherein:
the message includes information indicating a synchronization signal block (SSB) set to be used for transmitting the multiple preambles, and
the SSB set comprises multiple SSB indices, each SSB index corresponding to an SSB.

15. The method according to claim 14, wherein a sequence of the SSBs listed in the SSBs set indicates a sequence of SSBs used for transmitting the multiple preambles in time domain.

16. The method according to claim 14, wherein the SSB set is indicated by an SSB set index that is included in the message, and wherein correspondences between a plurality of SSB set indices and a plurality of SSB sets are preconfigured through a higher layer signaling.

17. The method according to claim 14, wherein the message indicates a set of associations of one or more PRACH occasions to the multiple SSB indices for transmitting the multiple PRACHs.

18. The method according to claim 10, wherein the UE receives the message through a Physical Downlink Control Channel (PDCCH) order.

19. (canceled)

20. A device, comprising:
a transceiver configured to:
receive a message from a base station to trigger a random-access process, the message comprising information for transmitting multiple preambles in one or more physical random-access channels (PRACHs);
transmit the multiple preambles according to the message from the base station; and
receive a random-access response from the base station.

21-22. (canceled)
